(19) United States
(12) Patent Application Publication
(10) Pub. No.: US 2023/0298775 A1
(43) Pub. Date: Sep. 21, 2023

(54) NUCLEAR REFUELLING DEVICE

(71) Applicant: ROLLS-ROYCE PLC, London (GB)

(72) Inventors: Daniel ROBERTSON, Derby, Derbyshire (GB); Euan SHARP, Derby, Derbyshire (GB); Gerard HALLIDAY, Derby, Derbyshire (GB); Stephen CALVERT, Derby, Derbyshire (GB); Matthew MORRIS, Derby, Derbyshire (GB)

(21) Appl. No.: 18/016,615

(22) PCT Filed: Jul. 14, 2021
(86) PCT No.: PCT/EP2021/069563

§ 371 Date: Jan. 17, 2023

(30) Foreign Application Priority Data
Jul. 23, 2020 (GB) 2011410.4

(51) Int. Cl. G21C 19/20; G21C 19/10; G21C 19/32

(52) U.S. Cl. CPC G21C 19/20; G21C 19/10; G21C 19/32

(57) ABSTRACT

The present disclosure provides a refuelling device for lifting a fuel rod assembly from a reactor core of a nuclear power generation system in a deployment location and transporting it to a storage location. The refuelling device comprises a device body having an open base and defining a chamber for housing a coolant. A sealing plate is movable between an open position in which the chamber is open and a closed position in which the chamber is sealed. The device further comprises a shielding element formed of radioactive shielding material and moveably mounted within the chamber. It has a storage cavity having an open lower end, the shielding element being movable between a retracted position in which it is fully contained within the chamber and an extended position in which it extends from the chamber through the open base of the device body. The device further comprises a rod lifting system having a rod connector for releasable connection to the fuel rod assembly and configured to raise the fuel rod assembly to within the storage cavity when the device is in the deployment location, the sealing plate is in the open position and the shielding element is in its extended position.

### TECHNICAL FIELD

The present disclosure relates to a device and method for refuelling a reactor core in a nuclear power generation system.

### BACKGROUND

Nuclear power plants convert heat energy from the nuclear decay of fissile material contained in fuel assemblies within a reactor core into electrical energy. Water-cooled reactor nuclear power plants, such as pressurised water reactor (PWR) plants, include a reactor pressure vessel (RPV) which contains the reactor core/fuel assemblies, and a turbine for generating electricity from steam produced by heat from the fuel assemblies.

PWR plants have a pressurised primary coolant circuit which flows through the RPV and transfers heat energy to one or more steam generators (heat exchangers) within a secondary circuit. The (lower pressure) secondary circuit comprises a steam turbine which drives a generator for the production of electricity. These components of a nuclear plant are conventionally housed in an airtight containment building, which may be in the form of a concrete structure.

The RPV typically comprises a body defining a cavity for containing the reactor core/fuel assemblies and a closure head for closing an upper opening to the cavity. The closure head may form part of an integrated head package (IHP) (or integrated head assembly) which further comprises a control rod drive mechanism contained within a shroud. The control rod drive mechanism comprises drive rods which pass through the closure head and are connected to control rods contained within the reactor core. The control rods are provided to absorb neutron radiation within the core and thus control the nuclear reactions within the reactor core. The drive rods within the control rod drive mechanism are powered by a power supply to vertically translate to thus raise and lower the control rods within the reactor core.

The reactor core further comprises guide columns for the control rods and these, along with the associated electronics are typically called the “upper internals”.

Maintenance and refuelling is an important part of the operation of a nuclear power generation system. Maintenance is required periodically e.g. to replace old and/or damaged parts of the system. Refuelling is required periodically (e.g. every 18-24 months) in order to replace spent fuel rods within the fuel rod assemblies.

When performing maintenance/refuelling of the reactor core, it is necessary to remove the IHP from the RPV, thereby revealing the reactor core. Once the reactor core is exposed, the upper internals are removed from the reactor core to access the fuel rod assemblies.

In order to perform maintenance and refuelling operations in a nuclear power generation system, an overhead crane arrangement such as a polar gantry crane having a circular runway is typically provided within the containment structure of the system. Polar cranes are necessarily large, heavy structures in order to allow the lifting of the heavy components of the nuclear power generation system. This makes polar cranes expensive to install.

During refuelling, the polar crane typically lifts the IHP from the RPV body vertically upwards, moves the IHP horizontally away from the RPV body and then lowers it onto a storage stand on the working floor within the containment building. The polar crane is then used to lift the upper internals which typically weigh around 15 to 50 tonnes and are radioactive. The polar crane raises the internals vertically and then horizontally before lowering them into a storage pool of water in which they are submerged. This is to provide gamma shielding around the internals during refuelling.

The reactor vessel body is typically located a significant distance below the working floor of the containment structure in order to provide a refuelling cavity above the exposed reactor core within the reactor vessel body. During removal of the IHP from the reactor vessel body, the drive rods remain connected to the control rods and protrude from the reactor vessel cavity into the refuelling cavity that is flooded with water to contain any radioactive emissions from the drive rods.

The water in the refuelling cavity also acts to shield and cool the spent fuel rods within the exposed reactor core. A height of 4 metres of water is required above the fuel rods/fuel assemblies for effective gamma shielding. Filling the refuelling cavity thus requires very large volumes of water and is thus time consuming.

The protruding drive rods and the vertical extent of the refuelling cavity drives the necessary lift height of the upper internals by the polar crane as the upper internals have to clear the vertical height of the drive rods/refuelling cavity before being moved horizontally and lowered into the storage pool.

The necessary lift height of the polar crane dictates the height of containment structure (and thus the cost/time associated with the building of the containment structure). The risks associated with dropping the upper internals from any significant vertical height onto the reactor core are very high.

To remove spent fuel rods, they are typically hoisted vertically from the reactor vessel body and then translated horizontally within the flooded refuelling cavity using a remotely operated overhead travelling crane. They are then rotated from a vertical position to a horizontal position (using a turnover rig) and subsequently transported out of the containment structure on a rod transport device via a flooded tunnel.

The overhead travelling crane is necessarily large and heavy and requires large concrete structures to support it within the containment structure. This makes such cranes expensive to install.

The process of removing the fuel rods requires transfer of the spent fuel rods between the crane, the turnover rig and the rod transport device making the process time-consuming and susceptible to malfunction. If the fuel rod removal process fails, the spent fuel rods may become trapped and inaccessible in the flooded tunnel.

There is a need for an improved nuclear power generation system which mitigates at least some of the problems associated with the known systems.

### SUMMARY OF DISCLOSURE

In a first aspect, there is provided a refuelling device for lifting a fuel rod assembly from a reactor core of a nuclear power generation system in a deployment location and transporting it to a storage location, the refuelling device comprising:
a device body having an open base and defining a chamber for housing a coolant;
a sealing plate movable between an open position in which the chamber is open and a closed position in which the chamber is sealed;
a shielding element formed of radioactive shielding material and moveably mounted within the chamber, the shielding element defining a storage cavity having an open lower end, wherein the shielding element is movable between a retracted position in which it is fully contained within the chamber and an extended position in which it extends from the chamber through the open base of the device body; and
a rod lifting system having a rod connector for releasable connection to the fuel rod assembly and configured to raise the fuel rod assembly to within the storage cavity when the refuelling device is in the deployment location, the sealing plate is in the open position and the shielding element is in its extended position.

By providing a device having a body with an open base that can be sealed by a movable plate to define a chamber to house coolant and that also contains a radioactive shielding element with a storage cavity, the fuel rod assembly can be withdrawn into the storage cavity at the deployment location using the rod lifting system and then transported within the refuelling device to the storage location (whilst being cooled by the coolant and shielded by the shielding element). The shielding element can extend from the device body into the reactor core/reactor vessel body so that the fuel rod assembly is contained within the shielding element as it is withdrawn into device body thus limiting radioactive emissions from the fuel rod assembly. Using this device, no refuelling cavity (or only a significantly reduced depth refuelling cavity) is required as only the reactor core/reactor vessel body need be flooded. The coolant-filled device can be positioned in the deployment location over the flooded reactor core/reactor vessel body the open base of the device body below the water line of the flooded rector core/reactor vessel body. In this way, the coolant remains within the device body as the sealing plate is moved to the open position to allow the shielding element to then extend into the reactor core. Accordingly, it can be seen that using such a device also obviates the need for the overhead travelling crane, the turnover rig and the flooded tunnel.

Optional features of the present disclosure will now be set out. These are applicable singly or in any combination with any aspect of the present disclosure.

In some embodiments, the device body may be formed of a radioactive shielding material such as steel. It may have an upper (substantially horizontal) wall and four (substantially vertical) side walls to form a cuboid chamber. The walls may each be between 100 and 200 mm, e.g. between 120 and 180 mm or between 140 and 160 mm such as around 150 mm thick. The walls may be lead-lined.

The sealing plate forms the base of the device body/chamber when it is in its closed position. In its closed position, it forms a liquid tight seal against the body to prevent seepage of any coolant from the chamber. The sealing plate may be formed of steel. It may have a thickness of between 100 and 200 mm, e.g. between 120 and 180 mm or between 140 and 160 mm such as around 150 mm. The sealing plate may be slidably movable or pivotally moveable between its open and closed positions. The sealing plate may be movable (e.g. slidably/pivotally movable) between its open and closed positions by an actuator that may be actuable (e.g. automatically actuable) by a control system located remotely from the refuelling device.

In some embodiments, the shielding element may be formed of lead. The shielding element may have an upper (substantially horizontal) wall. It may have four (substantially vertical) side walls to form a cuboid storage cavity or a cylindrical wall to form a cylindrical storage cavity. The walls may have a thickness of between 330-360 mm e.g. around 340 mm. The shielding element may comprise a lining tube (e.g. a steel lining tube) for lining the storage cavity to limit movement of the fuel rod assembly when within the storage cavity.

The shielding element is telescopically movable relative to the device body so that it is extendable/retractable through the open base of the device body when the sealing plate is in its open position. The refuelling device includes a shielding element lifting system for extending (lowering) and retracting (raising) the shielding element. The shielding element lifting system may comprise at least one rack and pinion system. For example, the shielding element lifting system may comprise a pinion mounted on or embedded in the device body (e.g. on/within a vertical wall of the device body) and a rack mounted on/embedded in the shielding element (e.g. on/within a vertical wall of the shielding element). In some embodiments, the shielding element lifting system may comprise a plurality of such rack and pinion systems e.g. with a rack mounted on each of the four vertical walls of the shielding element, each rack cooperating with a respective pinion mounted on the adjacent/facing device body vertical wall. In other embodiments, the shielding element lifting system may comprise one or more winches/hoists connected to the shielding element. The shielding element lifting system may actuable (e.g. automatically actuable) by the control system located remotely from the refuelling device.

In some embodiments, the rod lifting system comprises one or more winches/hoists. These may be mounted externally of the device body e.g. on an outer surface of the upper (horizontal) wall of the device body. An extendable/retractable winch/hoist cable carrying the rod connector will extend within the storage cavity e.g. through the upper walls of the device body and shielding element. The rod lifting system may actuable (e.g. automatically actuable) by the control system located remotely from the refuelling device. The rod connector may comprise a hook or grabber element which may be actuable (e.g. automatically actuable) by the control system located remotely from the refuelling device.

The refuelling device may further comprise a coolant circuit for circulating coolant (e.g. water or air). The coolant circuit may comprise a coolant inlet, a coolant outlet and a heat exchanger mounted externally on the refuelling device (e.g. on an outer surface of the device body) to release heat from the coolant into the containment structure atmosphere. The coolant circuit may comprise an air cooling circuit comprising at least one fan mounted on the device body.

In some embodiments, the refuelling device further comprises a wheeled frame for guiding movement of the lifting/transport device between the deployment location and the storage location.

The wheeled frame allows movement (e.g. horizontal movement) of the refuelling device (e.g. over a working floor of the containment structure) to move the refuelling device (and thus the fuel rod assembly) between the deployment location and the storage location.

The wheeled frame may comprise two parallel spaced rails with two perpendicular cross struts extending therebetween. The rails are mounted on frame wheels. The device body may be mounted on the cross struts. The frame wheels allow the movement of the refuelling device between the deployment location and the storage location. In some embodiments, the refuelling device further comprises a motor for driving the frame wheels to effect movement of the refuelling device from the deployment to the storage location. The motor may be actuable (e.g. automatically actuable) by the control system located remotely from the refuelling device. The frame wheels may be flanged wheels i.e. having a reduced diameter portion axially sandwiched between two flanges. In this way, the frame wheels may be configured to be driven along rails/tracks (e.g. rails/tracks on the working floor of the containment structure).

The device body may be movably mounted on the cross struts. For example, the device body may comprise device body wheels mounted on the cross struts to enable movement of the device body between and perpendicular to the wheeled rails (along the cross struts). The cross struts allow the adjustment of the position of the device body in the deployment location so that the device body can be positioned accurately vertically over the fuel rod assembly to be extracted. The refuelling device may further comprise a motor for driving the device body wheels. The motor may be actuable (e.g. automatically actuable) by the control system located remotely from the refuelling device. The device body wheels may be flanged wheels i.e. having a reduced diameter portion (for seating on the cross struts) axially sandwiched between two flanges.

The device may include an axial height adjustment mechanism for lowering the device body so that the open base is located below the coolant/water line prior to opening the sealing plate. The axial height adjustment mechanism may comprise one or more pistons. The axial height adjustment mechanism may comprise one or more rack and pinion gears. The axial height adjustment mechanism may be provided on the device body e.g. proximal the device body wheels.

The device may be collapsible. That is, the device may be configured to be moveable between a collapsed configuration and an expanded configuration. This may be facilitated, for example, by a structure of the device comprising telescoping, pivoting or hinged components. The device may include actuators for moving the device between its collapsed and expanded configurations. In the collapsed configuration the height and/or width of the device may be less than in the expanded configuration. The device may be movable (e.g. drivable) in the collapsed configuration. In this way, when the device is required to be moved through an opening e.g. into and out of the containment structure, the size of the opening (i.e. to accommodate the device) may be minimised. Thus, the device may be transported in the collapsed configuration and may perform the refuelling operation in the expanded configuration.

In a second aspect, there is provided a nuclear power generation system comprising a device according to the first aspect and a reactor vessel having:
a reactor vessel body defining a cavity housing a reactor core containing a control rod assembly and upper internals for guiding the control rod assembly; and
a closure head configured to seal against the reactor vessel body to close an opening to the reactor vessel body cavity.

The system may be a pressurised water reactor (PWR) system.

The reactor vessel may comprise an integrated head package (IHP) comprising the closure head, and a control rod drive mechanism housed within a shroud. The control rod drive mechanism comprises at least one drive rod (and preferably a plurality of drive rods) extending through the closure head, the or each drive rod having a coupling element (e.g. a pneumatic coupling element) for releasably coupling to a control rod assembly within the reactor core. The at least one drive rod is movable to a maintenance/refuelling position in which the at least one drive rod is uncoupled from the control rod assembly and at least partially (preferably fully) retracted into the IHP (e.g. into the shroud). The IHP further comprises at least one locking element for locking the at least one drive rod in the maintenance/refuelling position.

This IHP allows the drive rods to be removed from the reactor core along with the IHP. In this way, the need for a flooded refuelling cavity is removed as there will be no radioactive drive rods left protruding from the reactor core.

Accordingly, in some embodiments, the system comprises a containment structure where the working floor of the containment structure surrounds and is substantially vertically aligned with the opening to the reactor vessel cavity.

Given the scale of nuclear power generation systems, the term “substantially vertically aligned” means that the vertical spacing between the working floor and the opening to the reactor vessel cavity (defined by an upper end of the reactor vessel body) is less than 2 metres, e.g. 1 metre or 0.5 metres above the opening to the cavity in the reactor vessel body.

In some embodiments, the working floor comprises at least one pathway extending from adjacent the reactor vessel to the (remote) storage location, the at least one pathway being substantially vertically aligned with the opening to the reactor vessel cavity. The remote storage location may be provided externally to the containment structure e.g. in a shielded annex.

In some embodiments, the at least one pathway may be a linear pathway extending between the reactor vessel body and the storage location. In some embodiments, the at least one pathway may be a substantially horizontal pathway.

In some embodiments, the at least one pathway may comprise tracks/rails extending from between the reactor vessel body and the storage location, the frame wheels of the refuelling device being mounted on the tracks/rails. The tracks/rails may substantially vertically aligned with the opening to the cavity in the reactor vessel body. The use of tracks/rails may facilitate automation of movement of the refuelling device along the at least one pathway which, in turn may reduce the number of workers required to perform refuelling (which may reduce the safety risks associated with the processes).

In some embodiments, the deployment location of the lifting device is vertically above the reactor vessel body. In this way, when the sealing plate is in its open position, the shielding element and rod connector can be extended into the reactor core to engage the fuel rod assembly and to hoist it vertically upwards within the storage cavity.

In some embodiments, the system comprises a control system for sending control signals for actuation of the sealing plate and/or the rod lifting system and/or the shielding element lifting system and/or for driving the frame wheels/device body wheels. The control system (and any associated user interface) may be remote from the reactor vessel.

In some embodiments, the system is a pressurised water reactor system.

In a third aspect, there is provided a method of removing a fuel rod assembly from an exposed reactor core within a nuclear power generation system according to the second aspect using the refuelling device according to the first aspect.

In some embodiments, the method comprises:
after removal of the closure head (e.g. the integrated head package) and upper internals from the reactor vessel body, moving the refuelling device to the deployment location vertically above the coolant-flooded reactor vessel body (e.g. by driving the frame wheels along the pathway or tracks/rails) with the sealing plate in its closed position;
lowering the refuelling device so that the sealing plate is below the surface of the coolant;
moving the sealing plate to its open position;
lowering the shielding element and the rod connector (using the rod and shielding element lifting systems) and connecting the rod connector to the fuel rod assembly;
raising the fuel rod assembly vertically to within the storage cavity using the rod lifting system (e.g. by hoisting with the at least one winch/hoist);
raising the shielding element (and fuel rod assembly) to within the chamber (using the rod and shielding element lifting systems);
sealing the chamber by moving the sealing plate to its closed position; and
moving the refuelling device to the storage location (e.g. by driving the frame wheels along the pathway or tracks/rails).

At the storage location, the refuelling device can be lowered so that the sealing plate is below the surface of a spent fuel storage pool and the spent fuel rod assembly can be deposited into the spent fuel storage pool using the rod lifting system. In some embodiments, the shielding element is lowered into the storage pool with the spent fuel rod assembly before disconnection of the rod connector and subsequent retraction into the chamber of the shielding element and the rod connector.

In some embodiments, the method further comprises inserting a new fuel rod assembly into the exposed reactor core by:
moving the refuelling device to a fuel supply location vertically above a fuel supply pool with the sealing plate in its closed position;
lowering the refuelling device so that the sealing plate is below the surface of the fuel supply pool;
moving the sealing plate to its open position;
lowering the shielding element and the rod connector (using the rod and shielding element lifting systems) and connecting the rod connector to the new fuel rod assembly;
raising the new fuel rod assembly vertically to within the storage cavity using the rod lifting system (e.g. by hoisting with the at least one winch/hoist);
raising the shielding element (and new fuel rod assembly) to within the chamber (using the rod and shielding element lifting systems);
sealing the chamber by moving the sealing plate to its closed position; and
moving the refuelling device to the deployment location vertically above the coolant-flooded reactor vessel body (e.g. by driving the frame wheels along the pathway or tracks/rails);
lowering the refuelling device so that the sealing plate is below the surface of the coolant within the reactor vessel body;
moving the sealing plate to its open position;
lowering the shielding element and new fuel rod assembly (using the rod and shielding element lifting systems);
disconnecting the new fuel rod assembly from the rod connector;
raising the shielding element and rod connector to within the chamber (using the rod and shielding element lifting systems);
sealing the chamber by moving the sealing plate to its closed position; and
moving the refuelling device away from the deployment location (e.g. to the storage location) (e.g. by driving the wheels of the refuelling device along the pathway or tracks/rails).

In some embodiments, the method may comprise sliding or pivoting the sealing plate between its open and closed positions. The method may comprise remote actuation of the moveable sealing plate by a control system located remotely from the refuelling device i.e. the method may comprise sending an output signal from the control system to the actuator associated with the sealing plate (e.g. by input at the user interface of the remote control system) to effect movement (e.g. sliding/pivoting) of the sealing plate.

The method may comprise remote actuation of the rod and shielding element lifting systems by a control system located remotely from the refuelling device. Accordingly, the method may comprise sending an output signal from the control system to the lifting systems (e.g. by input at the user interface of the remote control system) to lower the shielding element and rod connector for shielding and connection of the fuel rod assembly/new fuel rod assembly. The method may comprise sending an output signal from the control system to the lifting systems (e.g. by input at the user interface of the remote control system) to raise the shielding element and rod connector after connection to/disconnection from the fuel rod assembly/new fuel rod assembly.

In some embodiments, the method further comprises circulating a coolant e.g. water or air through the refuelling device e.g. by passing the coolant into the refuelling device at a coolant inlet and out of the refuelling device (after cooling the fuel rod assembly within the storage cavity) from a coolant outlet and then through a heat exchanger to pass heat to the containment interior.

In some embodiments, the method comprises moving the refuelling device between the deployment and storage locations along a working floor of the containment structure (e.g. along a linear, horizontal pathway) that is substantially vertically aligned with the opening to the cavity.

The method may comprise moving the refuelling device to and from a storage location provided externally to the containment structure e.g. in a shielded annex.

In some embodiments, the method may comprise driving the frame wheels of the refuelling device along tracks or rails extending between the deployment location and the storage location, the frame wheels being mounted on the tracks/rails. The tracks/rails may substantially vertically aligned with the opening to the cavity in the reactor vessel body.

The method may comprise moving the refuelling device into the deployment location vertically over the reactor vessel body and adjusting the position of the device body in the deployment location so that the device body can be positioned accurately vertically over the fuel rod assembly to be extracted. This may be effected by adjusting the position of the device body on the cross struts (e.g. by driving the device body wheels).

The present invention may comprise, be comprised as part of a nuclear reactor power plant, or be used with a nuclear reactor power plant (referred to herein as a nuclear reactor). In particular, the present invention may relate to a Pressurized water reactor. The nuclear reactor power plant may have a power output between 250 and 600 MW or between 300 and 550 MW.

The nuclear reactor power plant may be a modular reactor. A modular reactor may be considered as a reactor comprised of a number of modules that are manufactured off site (e.g. in a factory) and then the modules are assembled into a nuclear reactor power plant on site by connecting the modules together. Any of the primary, secondary and/or tertiary circuits may be formed in a modular construction.

The nuclear reactor may comprise a primary circuit comprising a reactor pressure vessel; one or more steam generators and one or more pressurizer. The primary circuit circulates a medium (e.g. water) through the reactor pressure vessel to extract heat generated by nuclear fission in the core, the heat is then to delivered to the steam generators and transferred to the secondary circuit. The primary circuit may comprise between one and six steam generators; or between two and four steam generators; or may comprise three steam generators; or a range of any of the aforesaid numerical values. The primary circuit may comprise one; two; or more than two pressurizers. The primary circuit may comprise a circuit extending from the reactor pressure vessel to each of the steam generators, the circuits may carry hot medium to the steam generator from the reactor pressure vessel, and carry cooled medium from the steam generators back to the reactor pressure vessel. The medium may be circulated by one or more pumps. In some embodiments, the primary circuit may comprise one or two pumps per steam generator in the primary circuit.

In some embodiments, the medium circulated in the primary circuit may comprise water. In some embodiments, the medium may comprise a neutron absorbing substance added to the medium (e.g., boron, gadolinium). In some embodiments the pressure in the primary circuit may be at least 50, 80 100 or 150 bar during full power operations, and pressure may reach 80, 100, 150 or 180 bar during full power operations. In some embodiments, where water is the medium of the primary circuit, the heated water temperature of water leaving the reactor pressure vessel may be between 540 and 670 K, or between 560 and 650 K, or between 580 and 630 K during full power operations. In some embodiments, where water is the medium of the primary circuit, the cooled water temperature of water returning to the reactor pressure vessel may be between 510 and 600 k, or between 530 and 580 K during full power operations.

The nuclear reactor may comprise a secondary circuit comprising circulating loops of water which extract heat from the primary circuit in the steam generators to convert water to steam to drive turbines. In embodiments, the secondary loop may comprise one or two high pressure turbines and one or two low pressure turbines.

The secondary circuit may comprise a heat exchanger to condense steam to water as it is returned to the steam generator. The heat exchanger may be connected to a tertiary loop which may comprise a large body of water to act as a heat sink.

The reactor vessel may comprise a steel pressure vessel, the pressure vessel may be from 5 to 15 m high, or from 9.5 to 11.5 m high and the diameter may be between 2 and 7 m, or between 3 and 6 m, or between 4 to 5 m. The pressure vessel may comprise a reactor body and a reactor head positioned vertically above the reactor body. The reactor head may be connected to the reactor body by a series of studs that pass through a flange on the reactor head and a corresponding flange on the reactor body.

The reactor head may comprise an integrated head assembly in which a number of elements of the reactor structure may be consolidated into a single element. Included among the consolidated elements are a pressure vessel head, a cooling shroud, control rod drive mechanisms, a missile shield, a lifting rig, a hoist assembly, and a cable tray assembly.

The nuclear core may be comprised of a number of fuel assemblies, with the fuel assemblies containing fuel rods. The fuel rods may be formed of pellets of fissile material. The fuel assemblies may also include space for control rods. For example, the fuel assembly may provide a housing for a 17×17 grid of rods i.e. 289 total spaces. Of these 289 total spaces, 24 may be reserved for the control rods for the reactor, each of which may be formed of 24 control rodlets connected to a main arm, and one may be reserved for an instrumentation tube. The control rods are movable in and out of the core to provide control of the fission process undergone by the fuel, by absorbing neutrons released during nuclear fission. The reactor core may comprise between 100-300 fuel assemblies. Fully inserting the control rods may typically lead to a subcritical state in which the reactor is shutdown. Up to 100% of fuel assemblies in the reactor core may contain control rods.

Movement of the control rod may be moved by a control rod drive mechanism. The control rod drive mechanism may command and power actuators to lower and raise the control rods in and out of the fuel assembly, and to hold the position of the control rods relative to the core. The control rod drive mechanism rods may be able to rapidly insert the control rods to quickly shut down (i.e. scram) the reactor.

The primary circuit may be housed within a containment structure to retain steam from the primary circuit in the event of an accident. The containment may be between 15 and 60 m in diameter, or between 30 and 50 m in diameter. The containment structure may be formed from steel or concrete, or concrete lined with steel. The containment may contain within or support exterior to, a water tank for emergency cooling of the reactor. The containment may contain equipment and facilities to allow for refuelling of the reactor, for the storage of fuel assemblies and transportation of fuel assemblies between the inside and outside of the containment.

The power plant may contain one or more civil structures to protect reactor elements from external hazards (e.g. missile strike) and natural hazards (e.g. tsunami). The civil structures may be made from steel, or concrete, or a combination of both.

### BRIEF DESCRIPTION OF THE DRAWINGS

Embodiments will now be described by way of example only with reference to the accompanying drawings in which:

FIG. 1 shows a schematic cross-sectional view through the refuelling device with the shielding element in its retracted position;

FIG. 2 shows a schematic cross-sectional view through the refuelling device with the shielding element in its extended position; and

FIGS. 3a and 3b show a schematic top view and side view respectively of the refuelling device on its wheeled frame.

### DETAILED DESCRIPTION AND FURTHER OPTIONAL FEATURES

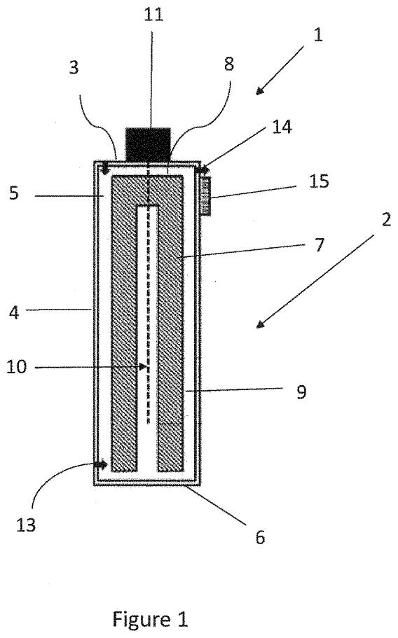

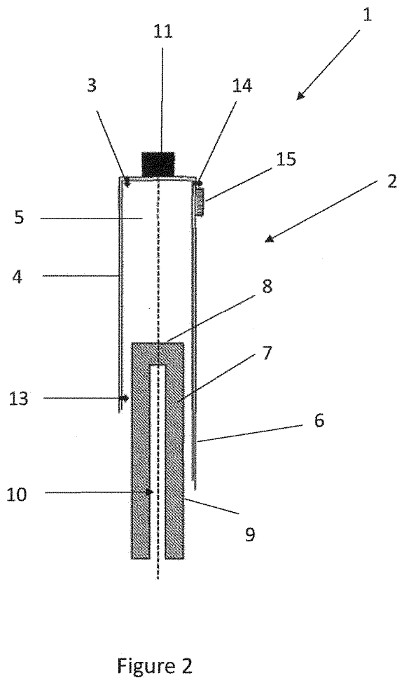

FIGS. 1 and 2 show a refuelling device 1 comprising a device body 2 having an open base, a horizontal upper wall 3 and vertical side walls 4. The walls are formed of 150 mm thick steel. The walls 3, 4 define a cuboid chamber 5.

The device further comprises a sealing plate 6 which is pivotally moveable between an open position (shown in FIG. 2) in which the chamber 5 is open (through the open base of the device body 2) and a closed position (shown in FIG. 1) in which the chamber 5 is sealed (in a liquid tight manner) with the sealing plate 6 covering the open base and sealed against the device body 2.

The sealing plate 6 is also formed of 150 mm thick steel and is associated with an actuator (not shown) for driving it between its open and closed positons. The actuator is operably connected to a control system located remotely from the device.

The device further comprises a shielding element 7 formed of lead and having an upper wall 8 and four vertical walls 9 with an open lower end. The shielding element 7 defines a storage cavity 10. The storage cavity may comprise a lining tube (not shown) formed of steel.

The shielding element 7 is telescopically mounted within the device body 2. The device 1 comprises a shielding element lifting system (not shown) for moving the shielding element 7 between a retracted position (shown in FIG. 1) and an extended position (shown in FIG. 2). The shielding element lifting system comprises four rack gears, one mounted on each of the vertical walls 9 of the shielding element 7. These rack gears cooperate with pinion gears mounted on the inner surface of the vertical walls 4 of the device body 2 adjacent each rack gear. In this way, the racks and pinions can move relative to each other to extend and retract the shielding element 7. The shielding element lifting system is operably connected to the remote control system.

A rod lifting system 11 is mounted outside the chamber 5 on the outer surface of the upper wall 3 of the device body 2. The rod lifting system 11 comprises a winch/hoist (outside the chamber 5) and a winch cable (not shown) which extends through the upper wall 3 of the device body 2 and through the upper wall 8 of the shielding element 7 into the storage cavity 10. At the end of the winch cable is a rod connector (not shown) for connection to a fuel assembly. The rod lifting system 11 is operably connected to the remote control system.

The device 1 further comprises a water coolant circulation system comprising a coolant inlet 13 and a coolant outlet 14 with a heat exchanger (radiator) 15 mounted on the outside surface of a vertical wall 4 of the device body 2 for releasing heat within the coolant into the atmosphere. When in use, the device body 2 is filled with coolant.

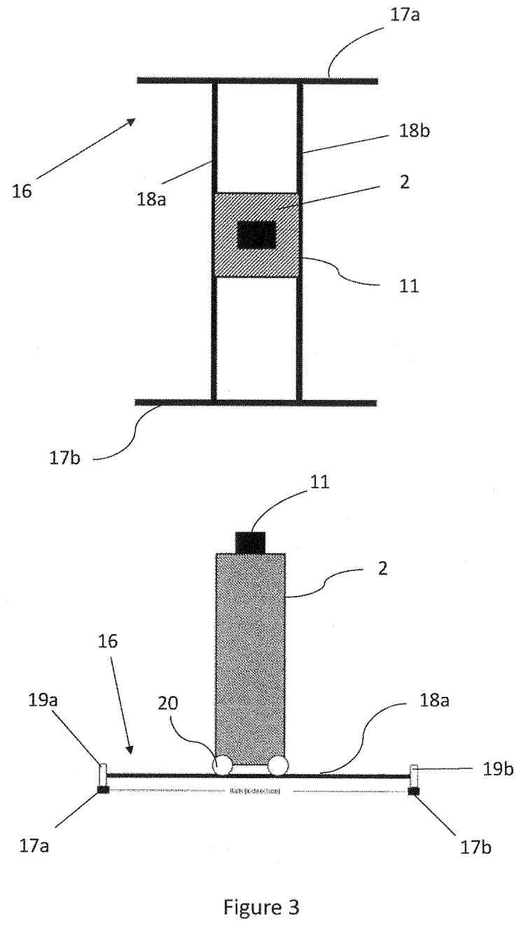

As shown in FIG. 3, the device body 2 is mounted on a wheeled frame 16 which comprises two parallel spaced rails 17a, 17b with two perpendicular cross struts 18a, 18b extending therebetween. The rails 17a, 17b are mounted on frame wheels 19a, 19b. The device body 2 comprises device body wheels 20 which are mounted on the cross struts 18a, 18b so that the device body 2 can move along the cross struts 18a, 18b perpendicular to the rails 17a, 17b. The refuelling device 1 further comprises motors (not shown) for independently driving the frame wheels 19a, 19b and the device body wheels 20 to effect two-dimensional movement of the device body. The motors are operatively coupled to the control system.

The refuelling device 1 is provided to facilitate the removal from (and subsequent replacement) of a fuel rod assembly within the reactor core of a pressurised water reactor power generation system. Such a system comprises a reactor vessel having a reactor vessel body (not shown) defining a cavity housing the reactor core. The reactor vessel also comprises an integrated head package (IHP) comprising a closure head configured to seal against the reactor vessel body to seal the reactor core. The reactor core contains the fuel rod assemblies and upper internals configured to maintain horizontal spacing of the fuel rod assemblies and associated control rods (which control the nuclear reactions within the reactor core).

In order to expose the reactor core (to allow replacement of the fuel rod assemblies), the IHP and upper internals must first be removed from the reactor vessel body. The reactor vessel body is flooded with coolant (e.g. water).

Subsequently, the refuelling device 1 is moved from a storage location (e.g. in a shielded annex outside the containment structure) to a deployment location vertically over the reactor vessel body. The refuelling device 1 is moved to the deployment location by driving the frame wheels 17a, 17b along rails/tracks extending along a linear pathway on the containment working floor. The working floor and rails/tracks are substantially vertically aligned with the opening to the cavity in the reactor vessel body.

Once in the deployment location, the horizontal position of the device body 2 over the reactor core is adjusted by driving the device body wheels 20 along the cross struts 18a, 18b until the device body 2 is directly above the fuel assembly for extraction.

Once correctly positioned, the device body 2 is lowered so that the sealing plate 6 is below the surface of the coolant within the reactor vessel body so that the coolant circulating within the device body 2 remains within the chamber 5 when the sealing plate 6 is moved to its open position (shown in FIG. 2) where the chamber 5 is open through the open base of the device body 2. The rod lifting system 11 lowers the rod connector into the reactor core through the open base (between the cross struts 18a, 18b). Similarly, the shielding element lifting system lowers the shielding element 7 into the reactor core until both the rod connector and shielding element are proximal the fuel rod assembly (as shown in FIG. 2). The rod connector connects to the fuel rod assembly and then the rod lifting system 11 retracts the fuel rod assembly and rod connector into the storage cavity 10 within the shielding element 7. Next the shielding element 7 and the fuel rod assembly contained within the storage cavity 10 are retracted within the device body 2 using the rod lifting system 11 and the shielding element lifting system. Once fully retracted, the sealing plate 6 is moved back to its closed position to seal the fuel rod assembly within the device body 2.

The refuelling device 1 can then be moved (horizontally) away from the deployment location by driving the frame wheels 19a, 19b along the rails/tracks.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A refuelling device for lifting a fuel rod assembly from a reactor core of a nuclear power generation system in a deployment location and transporting it to a storage location, the refuelling device comprising:
a device body having an open base and defining a chamber for housing a coolant;
a sealing plate movable between an open position in which the chamber is open and a closed position in which the chamber is sealed;
a shielding element formed of radioactive shielding material, the shielding element being moveably mounted within the chamber and defining a storage cavity having an open lower end, wherein the shielding element is movable between a retracted position in which it is fully contained within the chamber and an extended position in which it extends from the chamber through the open base of the device body; and
a rod lifting system having a rod connector for releasable connection to a fuel rod assembly and configured to raise the fuel rod assembly to within the storage cavity when the device is in the deployment location, the sealing plate is in the open position and the shielding element is in its extended position.

2. The refuelling device according to claim 1 wherein the device body is formed of steel and the shielding element is formed of lead.

3. The refuelling device according to claim 1 further including a shielding element lifting system for extending and retracting the shielding element.

4. The refuelling device according to claim 3 wherein the shielding element lifting system comprises a pinion mounted on or embedded in the device body and a rack mounted on/embedded in the shielding element.

5. The refuelling device according to claim 1, wherein the rod lifting system comprises one or more winches/hoists mounted on an outer surface of the device body.

6. The refuelling device according to claim 1 further comprising a coolant circuit comprising a coolant inlet, a coolant outlet and a heat exchanger mounted externally on the device.

7. The refuelling device according to claim 1 comprising a wheeled frame for guiding movement of the refuelling device between the deployment location and the storage location.

8. The refuelling device according to claim 7 comprising two parallel spaced rails having frame wheels with two perpendicular cross struts extending therebetween, the device body being movably mounted on the cross struts.

9. A nuclear power generation system comprising a refuelling device according to claim 1 and a reactor vessel having:
a reactor vessel body defining a cavity housing a reactor core containing a control rod assembly and upper internals for guiding the control rod assembly; and
a closure head configured to seal against the reactor vessel body to close an opening to the reactor vessel body cavity.

10. The nuclear power generation system according to claim 9 comprising an integrated head package comprising the closure head, and a control rod drive mechanism housed within a shroud, the control rod drive mechanism comprising at least one drive rod extending through the closure head, the or each drive rod having a coupling element for releasably coupling to a control rod assembly within the reactor core, the at least one drive rod being movable to a maintenance/refuelling position in which the at least one drive rod is uncoupled from the control rod assembly and at least partially retracted into the integrated head package, the integrated head package further comprising at least one locking element for locking the at least one drive rod in the maintenance/refuelling position.

11. The nuclear power generation system according to claim 10 comprising a containment structure where the working floor of the containment structure surrounds and is substantially vertically aligned with the opening to the cavity.

12. The nuclear power generation system according to claim 11 wherein the working floor comprises at least one pathway extending from adjacent the reactor vessel to the storage location, the at least one pathway comprising tracks/rails substantially vertically aligned with the opening to the cavity in the reactor vessel body.

13. The nuclear power generation system according to claim 10 further comprising a control system for sending control signals for actuation of the sealing plate and/or the rod lifting system and/or the shielding element lifting system and/or for driving the frame wheels/device body wheels.

14. The nuclear power generation system according to claim 10 wherein the system is a pressurised water reactor system.

15. A method of removing a fuel rod assembly from an exposed reactor core within a nuclear power generation system according to claim 9 using the refuelling device according claim 1, the method comprising:
removing the closure head and upper internals from the reactor vessel body,
after removal of the closure head and upper internals from the reactor vessel body, moving the refuelling device to the deployment location vertically above the coolant-flooded reactor vessel body with the sealing plate in its closed position;
lowering the device so that the sealing plate is below the surface of the coolant;
moving the sealing plate to its open position;
lowering the shielding element and the rod connector and connecting the rod connector to the fuel rod assembly;
raising the fuel rod assembly vertically to within the storage cavity using the rod lifting system;
raising the shielding element and fuel rod assembly to within the chamber;
sealing the chamber by moving the sealing plate to its closed position; and moving the device to the storage location.

16. The method according to claim 15 further comprising circulating a coolant e.g. water or air through the device.

17. The method according to claim 15 comprising moving the refuelling device between the deployment and storage locations along a working floor of the containment structure that is substantially vertically aligned with the opening to the cavity.

18. The method according to claim 15 comprising moving the refuelling device to and from a storage location provided externally to the containment structure.

19. The method according to claim 15 comprising driving the frame wheels of the device along tracks or rails extending between the deployment location and the storage location and adjusting the deployment location by driving the device body wheels along the cross struts.
